(19) United States
(12) Patent Application Publication
(10) Pub. No.: US 2015/0172291 A1
(43) Pub. Date: Jun. 18, 2015

(54) VERIFYING USER IDENTITY

(71) Applicants: Chi Zhang, Beijing (CN); Kun Fang, Beijing (CN); Xiaohu Dong, Beijing (CN)

(72) Inventors: Chi Zhang, Beijing (CN); Kun Fang, Beijing (CN); Xiaohu Dong, Beijing (CN)

(73) Assignee: Google Inc., Mountain View, CA (US)

(21) Appl. No.: 14/407,931

(22) PCT Filed: Jun. 14, 2012
(86) PCT No.: PCT/CN2012/076910

§ 371 Date: Dec. 12, 2014

(51) Int. Cl. H04L 29/06; G06F 21/31; H04L 9/32

(52) U.S. Cl. CPC H04L 63/0884; H04L 9/3236; G06F 21/31

(57) ABSTRACT

A system and method for verifying user identity. A user input is received, the user input being associated with verifying a user's identity on a server. At least one parameter of a one-way function for processing the received user input is determined. The at least one parameter is associated with the server. The user input is processed with the one-way function based on the determined at least one parameter. The processed user input is sent to the server. In response to sending the processed user input, a verification of the user's identity is received from the server.

### FIELD

The subject technology generally relates to verifying user identity and, in particular, relates to verifying user identity based on received user input.

### BACKGROUND

User passwords are often provided to a service providers and transferred over the Internet, for example, in plain text. If a user uses the same password for several service providers and that password is compromised at one service provider, it is possible for the user's account information at the other service providers to also be at risk.

### SUMMARY

The disclosed subject matter relates to a machine-implemented method for verifying user identity. The method comprises receiving a user input, wherein the user input is associated with verifying a user's identity on a server. The method further comprises determining at least one parameter of a one-way function for processing the received user input, wherein the at least one parameter is associated with the server, and processing the user input with the one-way function based on the determined at least one parameter. In addition, the method comprises sending the processed user input to the server, and receiving, in response to sending the processed user input, a verification of the user's identity from the server.

The disclosed subject matter further relates to a system for verifying user identity. The system comprises one or more processors, and a machine-readable medium comprising instructions stored therein, which when executed by the processors, cause the processors to perform operations comprising receiving a user input, wherein the user input is associated with verifying a user's identity on a server. The operations further comprise determining at least one parameter of a hash function for cryptographically processing the received user input, wherein the at least one parameter is associated with the server, processing the user input with the hash function based on the determined at least one parameter, and sending the processed user input to the server. In addition, the operations comprise receiving, in response to sending the processed user input, a verification of the user's identity from the server.

The disclosed subject matter also relates to a machine-readable medium comprising instructions stored therein, which when executed by a system, cause the system to perform operations comprising receiving a user input, wherein the user input is associated with verifying a user's identity on a server, and sending a request for information to a server, the information for identifying a type of one-way function for processing the received user input. The operations further comprise receiving, in response to sending the request, the information from the server, processing the user input with the one-way function based on the received information, sending the processed user input to the server, and receiving, in response to sending the processed user input, a verification of the user's identity from the server.

The disclosed subject matter relates to a machine-implemented method of verifying user identify at a server. The method comprises receiving a request for information from a client device, the information for identifying a type of one-way function to use for processing a user input, wherein the user input is associated with verifying a user's identity for a service, and determining the information in response to the received request. The method further comprises sending the determined information to the client device, receiving, in response to sending the determined information, a processed user input from the client device, and verifying the user's identity based on the processed user input.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example distributed network environment which can provide for verifying user identity.

FIG. 2 is a block diagram illustrating an example of verifying user identity between a client and a server.

FIG. 3 is a block diagram illustrating another example of verifying user identity between a client and a server.

FIGS. 4A and 4B are block diagrams illustrating an example of verifying user identity between a client and two servers.

FIGS. 5A and 5B are block diagrams illustrating another example of verifying user identity between a client and two servers.

FIG. 6 illustrates an example process by which user identify is verified at a client.

FIG. 7 illustrates an example process by which user identify is verified at a server.

FIG. 8 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

A user input (e.g., password or an answer to a security question) is received at a client device, where the user input is associated with verifying a user's identity on a server. At least one parameter of a one-way function (e.g., a hash function) for processing the received user input is determined, where the at least one parameter is associated with the server. The user input is processed with the one-way function based on the determined at least one parameter. The processed user input is sent from the client to the server. The server verifies the user's identity based on the processed user input. A verification of the user's identity is sent from the server to the client.

The at least one parameter can include a first parameter for identifying the server, and a second parameter (e.g., corresponding to a single parameter or a set of parameters) for identifying a type of one-way function for processing the user input. The first parameter can be sharable with multiple servers to identify the multiple servers, or can uniquely identify the server from among other servers. The second parameter can further specify or alter how the identified type of one-way function works. The second parameter can be a preset value which is specified within a login context associated with the server, or can be a value received from the server in response to a request from the client for identifying the type of one-way function to use.

As such, a user's plain password (or answer to a security question) can be completely hidden from a service provider without affecting password-based authentication. Furthermore, different service providers can receive different passwords from an electronic device of the user, while the user may only have to remember one password.

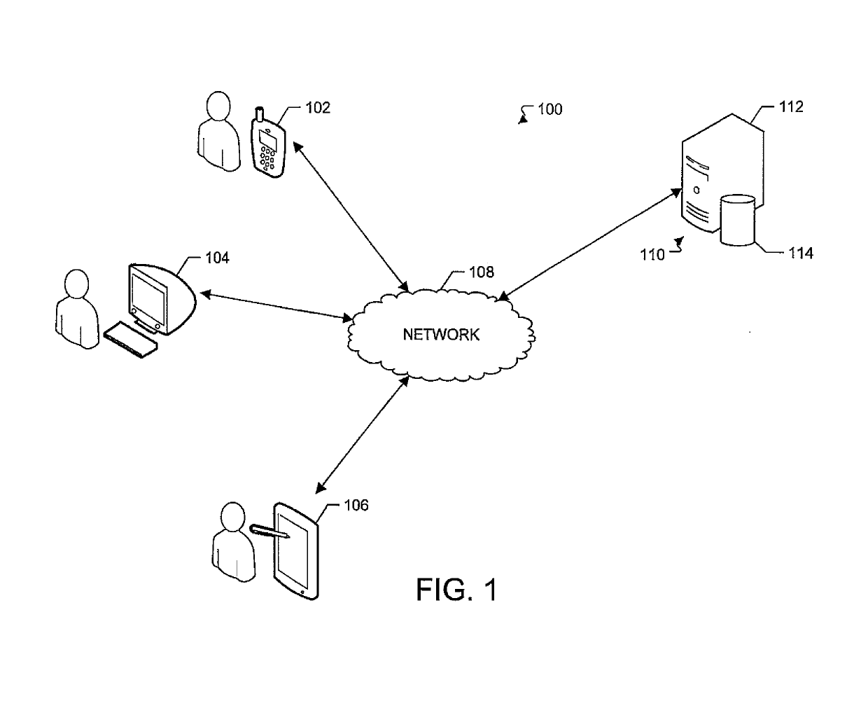

FIG. 1 illustrates an example distributed network environment which can provide for verifying user identity. A network environment 100 includes a number of electronic devices 102-106 communicably connected to a server 110 by a network 108. Server 110 includes a processing device 112 and a data store 114. Processing device 112 executes computer instructions stored in data store 114, for example, to host an application (e.g., a website). Users may interact with the application, via network 108, using any one of electronic devices 102-106.

In example aspects, a verification of user identify (e.g., for the application hosted by server 110) can be performed. User input is received at any one of electronic devices 102-106. The user input is associated with verifying a user's identity on server 110 (e.g., for an application/service provided by server 110). At least one parameter of a one-way function for processing the received user input is determined, the at least one parameter being associated with server 110. The user input is processed at the electronic device (e.g., 102-106) with the one-way function based on the determined at least one parameter. The electronic device (e.g., 102-106) sends the processed user input to server 110. Server 110 verifies the user's identity based on the processed user input, and server 110 sends verification of the user's identify to the electronic device (e.g., 102-106). Since server 110 only receives the processed user input, not the user input, the user input may be better protected.

Electronic devices 102-106 can be computing devices such as laptop or desktop computers, smartphones, PDAs, portable media players, tablet computers, or other appropriate computing devices that can be used, for example, to access web applications. In the example of FIG. 1, electronic device 102 is depicted as a smartphone, electronic device 104 is depicted as a desktop computer, and electronic device 106 is depicted as a PDA.

In some example aspects, server 110 can be a single computing device such as a computer server. In other embodiments, server 110 can represent more than one computing devices working together to perform the actions of a server computer (e.g., cloud computing). Examples of computing devices that may be used to implement server 110 include, but are not limited to, a web server, an application server, a proxy server, a network server, or a group of computing devices in a server farm.

Communication between any of electronic devices 102-106 and server 110 may be facilitated through a network (e.g., network 108). Network 108 can be a public communication network (e.g., the Internet, cellular data network, dialup modems over a telephone network) or a private communications network (e.g., private LAN, leased lines). Communications between any of electronic devices 102-106 and server 110 may be facilitated through a communication protocol such as Hypertext Transfer Protocol (HTTP). Other communication protocols may also be facilitated for some or all communication between any of electronic devices 102-106 and server 110, including for example, Extensible Messaging and Presence Protocol (XMPP) communication.

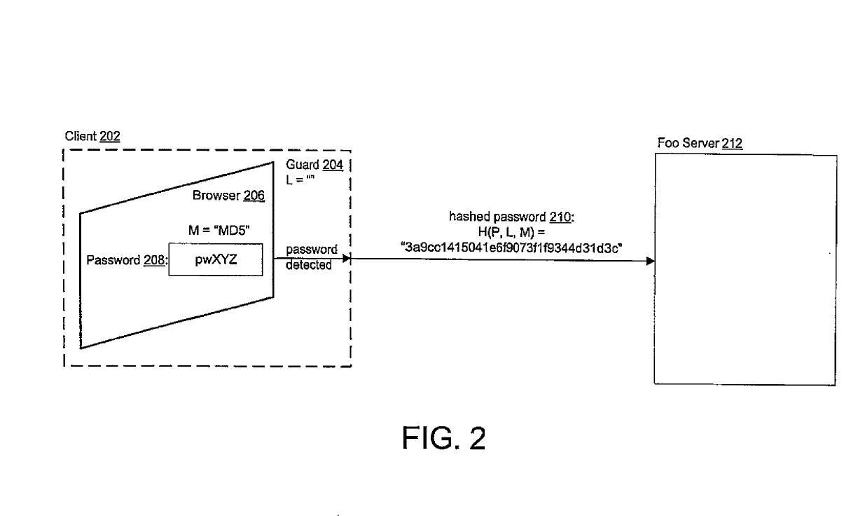

FIG. 2-FIG. 5B, which will be described separately later, illustrate examples of verifying user identities between a client and a server. The subject disclosure provides for processing a user's plain password before sending to a server(s), and sending the processed password to the server. The processing combines different parameters, which may be generated from various sources. In example aspects, a protocol and several programs may be used at both the client side and the server side.

At the client side, programs may include, but are not limited to, a web browser for accessing a service on the server, a browser plugin or a daemon process. In the example of FIG. 2-FIG. 5B, the daemon process is referred to as a “guard”. The guard can run locally at the client to detect login attempts.

The guard can provide for a general hash process which consists of a set of predefined one-way functions (e.g., standard cryptographic hash functions). In the examples of FIG. 2-FIG. 5B, the hash process is referred to as H(P, L, M), with “H” representing the hash function, “P” representing the user's entered password, “L” representing a parameter for identifying the server, and “M” representing a parameter for identifying the type of one-way function (e.g., hash function) to be used. In addition to identifying the type of one-way function, M can further include information specifying or altering how the identified type of one-way function works. M may include a hash function, and may also include one or more parameters for that function. The hash function specified in M may be chosen from, e.g., MD5, MD6, SHA-1, or any other public or proprietary hash functions. The choosing of M parameter(s) may depend on the M function. For example, if the M function is MD5, M parameter may be an arbitrary string that is randomly generated. In some implementations, M may be embedded in a login page, and the security of M may solely depend on public protocols (e.g. HTTPS) and/or applications (e.g. Web Browser). In some implementations, M may be on-demand, so that service providers may use their own proprietary ways to protect M. For example, a bank may require a user to insert a special USB key into a computer to get an M.

When a login attempt is detected by the guard, the guard can consume and transform P (the user password) using hash process H. The parameters L and M can be generated in different ways. In example aspects, L may be a fixed value or a mapped value. In a case where L is fixed, L can be fixed for all service providers. For example, L can be empty, or pre-generated and stored in local memory (e.g., in a lookup table). In a case where L is mapped, different service providers can be made to correspond with different L values. In this regard, L can be pre-generated and stored in local memory (e.g., in a lookup table).

L can be generated when a user registers on a service provider for the first time. When a login attempt is detected, the guard can map the current service provider to the corresponding L. For example, such matching can be based on the domain of the service provider, a certificate used by the service provider, or an authorized account ID. L can be a permanent value. Alternatively, L can have an expiration time. In such a case, the user and service provider may be notified when L is re-generated, or may not be notified when L is re-generated.

In example aspects, M can be fixed or can be an on-demand value. In a case where M is fixed, M can be fixed and pre-specified by a service provider within a login context. For example, M can be fixed and pre-specified in association with a login page. In another example, M can be fixed and pre-specified in association with a user registration for the service provider.

In a case where M is an on-demand value, M can be generated on-demand by a service provider (e.g., on a login attempt). In this case, the guard can issue a request to a corresponding server. In response, the server can provide M to the guard. In example aspects, M can be generated so as to minimize being faked by other service providers. For example, this can be achieved by using a certificate system (e.g., as in https). M can be a permanent value. Alternatively, the service provider can change M for each login attempt.

On the server side, depending on how M is generated or specified, the server can handle different requests from the client device. In a case where M is fixed, the server can pre-specify M in a login context (e.g., in a login page, registration, etc.). On a login attempt, the server can validate the received hashed password. In a case where M is on-demand, the server can respond to the request sent from the client device (e.g., from the guard of the client device) with the value for M.

As such, a one-way function (e.g., a hash function) can be used in verifying user identify for an application hosted on a server. In general, a one-way function is difficult to invert, and can be used to process a password within a login context. The processed password can be sent to the service provider and used for user identity validation. Consequently, the password may be completely hidden from the service provider without affecting password-based authentication.

The one-way function may be defined by one parameter, L or M, although being defined by two parameters may provide more security to the user input.

Furthermore, the one-way function may be specific to a service provider, so that each service provider may receive different processed passwords even when the user uses only one password for all service providers. In the examples of FIG. 2-FIG. 5B, by using a hash function H with parameters L and M, the plain password P can be transformed into a hashed password, with only the hashed password being sent to the server. Each of FIG. 2-FIG. 5B will now be described in further detail.

FIG. 2 is a block diagram illustrating an example of verifying user identity between a client and a server. In FIG. 2, an example flow between a client 202 and a service provider, foo server 212, for a protocol variant with a fixed L and a fixed M is illustrated. Client 202 includes a guard 204 and a browser 206.

More specifically, L is pre-specified and fixed to an empty string (e.g., L=“ ”). M is pre-specified and fixed in a login page or at user registration by foo server 212 (e.g., in webpage source code). In the example of FIG. 2, M=“MD5”. Of course, other values for M can be used. As noted above, M can further include information specifying or altering how the identified type of one-way function works. For example, in addition to determining the type of hash function (e.g., “MD5”), M can specify a prefix of “imsalt_”, so that while processing a user input (e.g., “pwXYZ”), the input for the MD5 function becomes “imsalt_pwXYZ”. It should be noted that adding a prefix to an input password is one example of specifying or altering the one-way function, and that other parameters and different ways of specifying how the hash process works can be employed.

A user enters a plain password 208 (e.g., “pwXYZ”) in password form into browser 206. This login attempt is detected by guard 204, and guard 204 consumes the password. Guard 204 then performs hash function H(P, L, M) on the entered user password (or on the altered input, with the “imsalt_” prefix for example, if specified by M), where the type of hash function is specified as “MD5” via parameter M. For example, H(P, L, M)=“3a9cc1415041e6f9073f1f9344d31d3c”, corresponding to the hashed password 210. The hashed password 210 can then be sent to foo server 212 for user identity validation. A verification of the user identify can then be sent from foo server 212 to client 202.

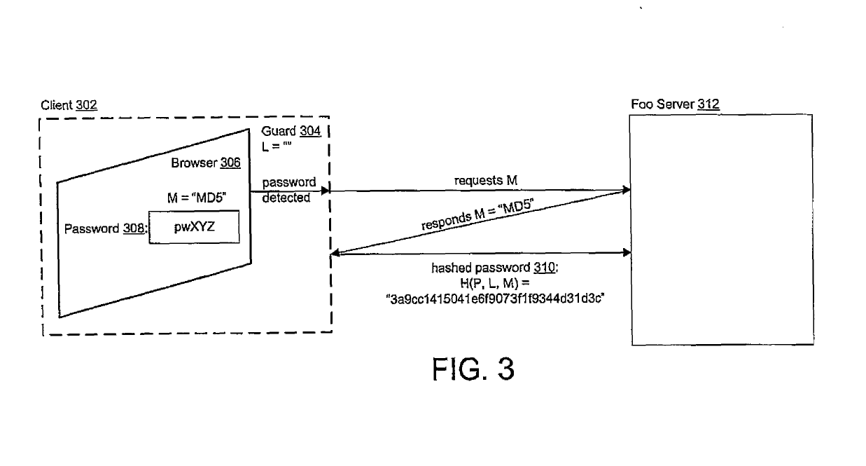

FIG. 3 is a block diagram illustrating another example of verifying user identity between a client and a server. In FIG. 3, an example flow between a client 202 and a service provider, foo server 312, for a protocol variant with a fixed L value and an on-demand M value is illustrated. Client 302 includes a guard 304 and a browser 306.

More specifically, L is pre-specified and fixed to an empty string (e.g., L=“ ”). A user enters a plain password 308 (e.g., “pwXYZ”) in password form into browser 306. This login attempt is detected by guard 304, and guard 304 consumes the password. Guard 304 then issues a request to foo server 312, requesting for M, the parameter for identifying the type of hash function to be used. Foo server 312 responds to guard 304 with M=“MD5”, specifying that MD5 is the hash function to be used. Foo server 312 can further respond that M includes information specifying or altering how the identified hash function works.

Guard 304 receives M and performs the hash function H(P, L, M) on the user password, using MD5. Guard 304 then obtains the hashed password 310. For example, H(P, L, M)=“3a9cc1415041e6f9073f1f9344d31d3e” corresponds to hashed password 310. Hashed password 310 is sent to foo server 312 for user identity validation. A verification of the user identify can then be sent from foo server 312 to client 302.

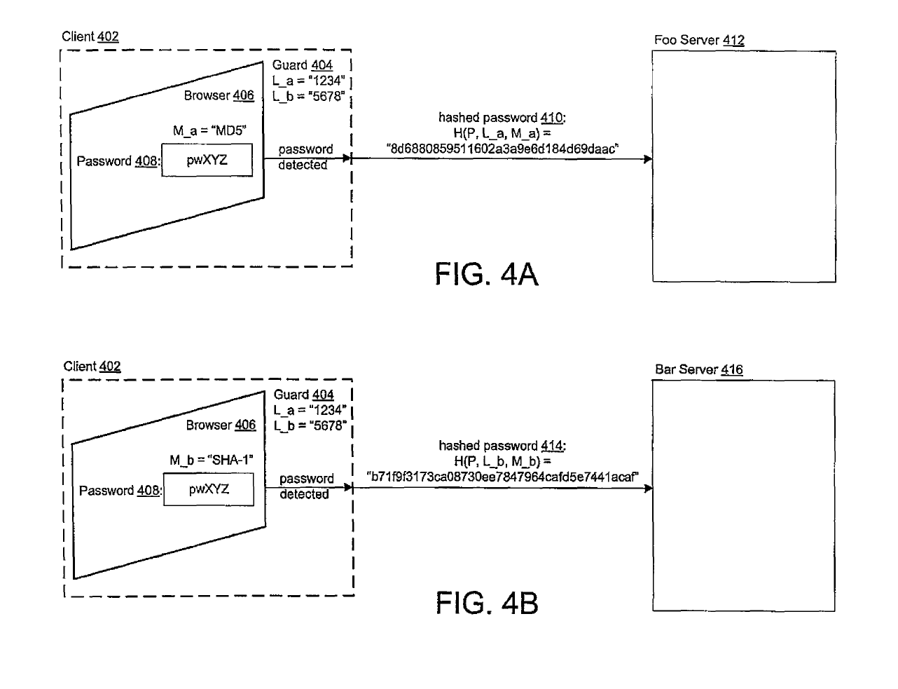

FIGS. 4A and 4B are block diagrams illustrating an example of verifying user identity between a client and two servers. In FIGS. 4A and 4B, an example flow between client 402 and two service providers, foo server 412 and bar server 416, for a protocol variant with a mapped L value and a fixed M value is illustrated. Client 402 includes a guard 404 and a browser 406.

More specifically, the L values are pre-specified and generated locally for the two service providers foo server 412 and bar server 416 (e.g., L_a=“1234” for foo server 412, and L_b=“5678” for bar server 416.

Foo server 412 pre-specifies and fixes M_a in a login page or at user registration (e.g., in webpage source code). In the example of FIG. 4A, M_a=“MD5”. For foo server 412, a user enters plain password 408 (e.g., “pxWYZ”) in password form into browser 406. The login attempt is detected by guard 404, and guard 404 maps foo server 412 to corresponding L_a and consumes the password. Guard 404 then performs the hash function H(P, L_a, M_a) on user password, using MD5. Guard 404 then obtains the hashed password 410. For example, H(P, L_a, M_a)=“8d6880859511602a3a9e6d184d69daac” corresponds to hashed password 410. Hashed password 410 is sent to foo server 412 for user identity validation. A verification of the user identify can then be sent from foo server 412 to client 402.

With bar server 416, the user can enter the same plain password 408. In the example of FIG. 4B, bar server 416 uses the SHA-1 hash function as specified in M_b, and guard 404 locally uses a different L_b for bar server 416. Guard 404 then automatically maps bar server 416 to L_b, and bar server 416 receives a hashed password 414. For example, H(P, L_b, M_b) “b71f9f3173ca08730ee7847964cafd5e7441acaf” corresponds to hashed password 414, which is different than hashed password 410. Hashed password 414 is sent to bar server 416 for user identity validation. A verification of the user identify can then be sent from bar server 416 to client 402.

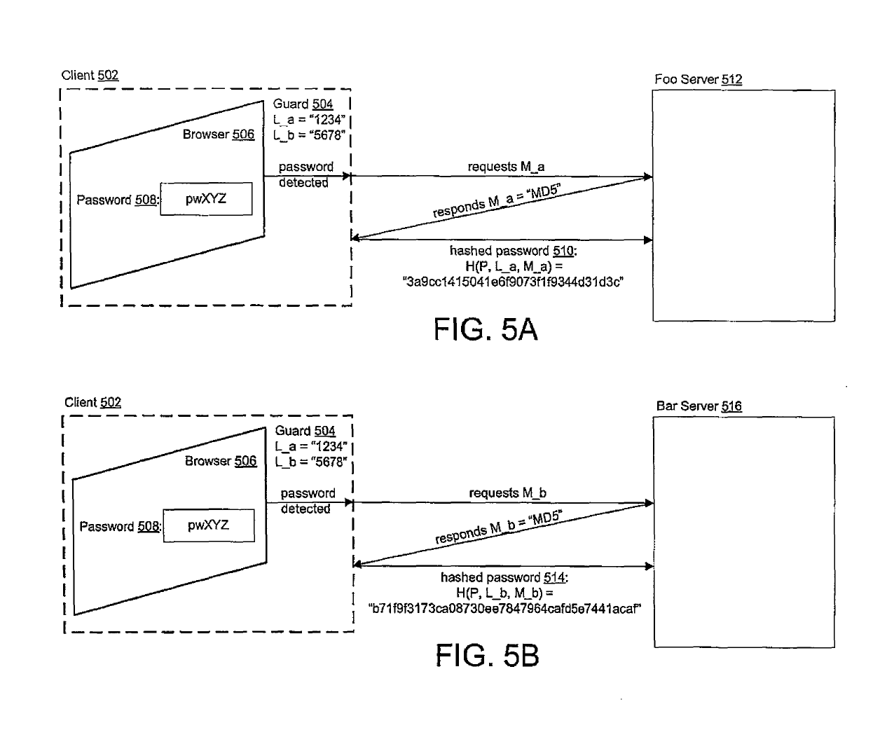

FIGS. 5A and 5B are block diagrams illustrating another example of verifying user identity between a client and two servers. In FIGS. 5A and 5B, an example flow between client 502 and two service providers, foo server 512 and bar server 516, for a protocol variant with a mapped L value and an on-demand M value is illustrated. Client 502 includes a guard 504 and a browser 506.

More specifically, the L values are pre-specified and generated locally for the two service providers foo server 512 and bar server 516 (e.g., L_a=“1234” for foo server 512, and L_b=“5678” for bar server 516).

For foo server 512, a user enters a plain password 508 (e.g., “pxWYZ”) in password form into browser 506. This login attempt is detected by guard 504, and guard 504 maps foo server 512 to corresponding L_a and consumes the password. Guard 504 issues a request to foo server 512 asking for M_a. Foe server 512 responds to guard 504 with M_a=“MD5”, specifying that MD5 is the hash function to be used.

Guard 504 receives M_a and performs the hash function H(P, L_a, M_a) on the user password, using MD5. Guard 504 obtains the hashed password 510. For example, H(P, L_a, M_a)=“3a9cc1415041e6f9073f1f9344d31d3c”. Hashed password 510 is then sent to foo server 512 for user identity validation. A verification of the user identify can then be sent from foo server 512 to client 502.

For bar server 516, the user can enter the same plain password 508. Bar server 516 uses the SHA-1 hash function as specified in M_b, and guard 504 locally uses a different L_b for bar 516. Guard 504 will automatically map bar server 516 to Lb. Bar server 516 will receive a hashed password 514. For example, H(P, L_b, M_b)=“b71f9f3173ca08730e07847964cafd5e7441acaf” corresponds to hashed password 514, which is different than hashed password 510. Hashed password 510 is sent to bar server 516 for user identity validation. A verification of the user identify can then be sent from bar server 516 to client 502.

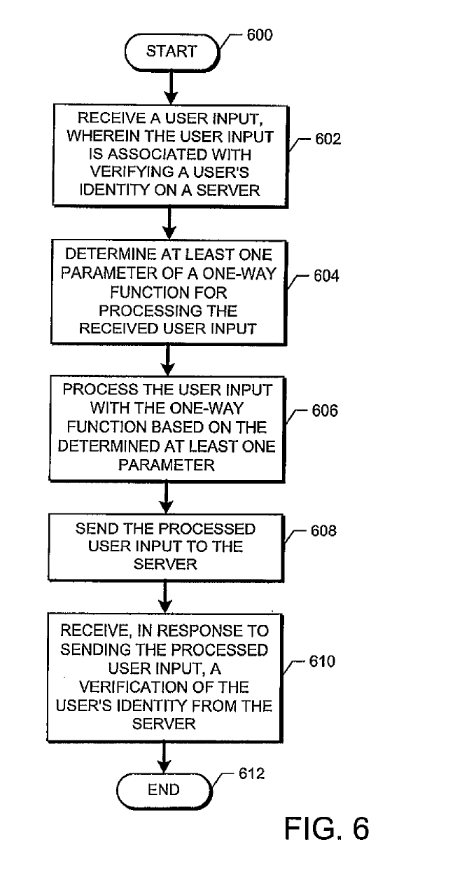

FIG. 6 illustrates an example process by which user identify is verified at a client device. Following start block 600, a user input is received at block 602. The user input is associated with verifying a user's identity on a server. The user input can include at least one of a password or an answer to a security question.

At step 604, at least one parameter of a one-way function for processing the received user input is determined. The at least one parameter is associated with the server. The one-way function can be a hash function for cryptographically processing the user input.

The at least one parameter can include a first parameter for identifying the server. The first parameter can be a locally-stored parameter. The first parameter can be sharable with multiple servers to identify the multiple servers. The first parameter can uniquely identify the server from among other servers.

In addition, the at least one parameter can include a second parameter (e.g., corresponding to a single parameter or a set of parameters) for identifying a type of one-way function for processing the user input. The second parameter can also specify or alter how the identified type of one-way function works. The second parameter can be a preset value which is specified within a login context associated with the server. In example aspects, a request for identifying the type of one-way function can be sent to the server. In response to sending the request, the second parameter can be received from the sewer.

At step 606, the user input is processed with the one-way function based on the determined at least one parameter. At step 608, the processed user input is sent to the server.

At step 610, in response to sending the processed user input, a verification of the user's identity is received from the server. The receiving the user input, determining the at least one parameter, processing the user input, sending the processed user input, and receiving the verification can be separately performed in association with a first server and a second server. The processed user input sent to the first server can differ from the processed user input sent to the second server. The process then ends at end block 612.

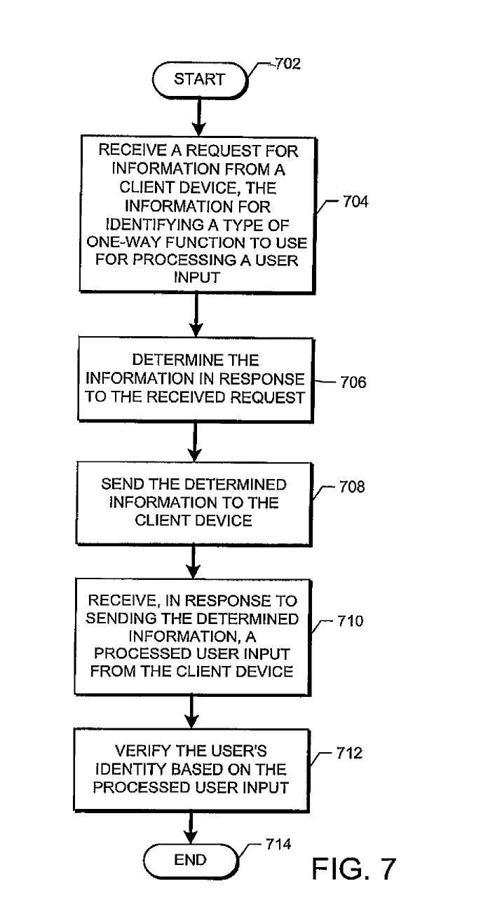

FIG. 7 illustrates an example process by which user identify is verified at a server. Following start block 702, a request for information is received from a client device at step 704. The information identifies a type of one-way function to use for processing a user input, and the user input is associated with verifying a user's identity for a service. The information can further specify or alter how the identified type of one-way function works. The one-way function can be a hash function for cryptographically processing the user input.

At step 706, the information is determined in response to the received request. At step 708, the determined information is sent to the client device. At step 710, in response to sending the determined information, a processed user input is received from the client device. At step 712, the user's identity is verified based on the processed user input. A verification of the user's identify can be sent to the client. The process then ends at end block 714.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

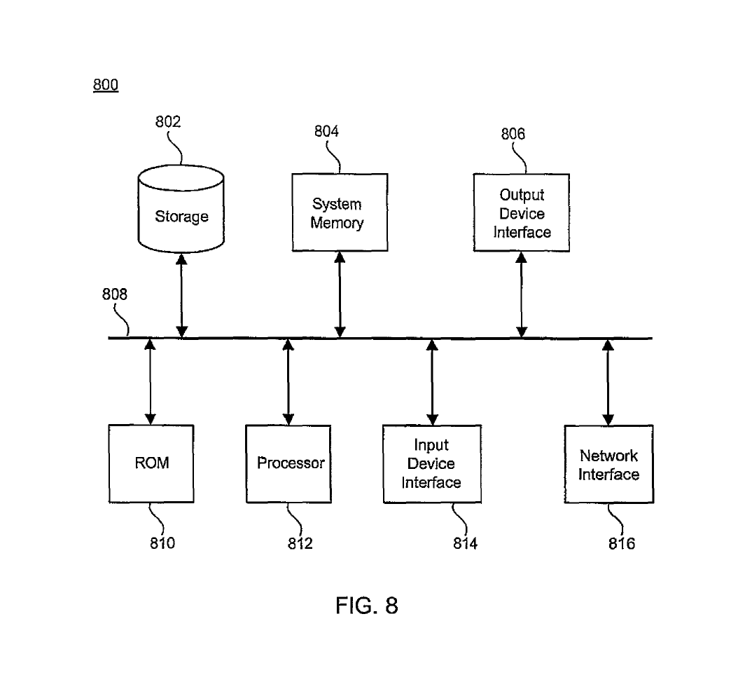

FIG. 8 conceptually illustrates an electronic system with which some implementations of the subject technology are implemented. Electronic system 800 can be a computer, phone, PDA, or any other sort of electronic device. Such an electronic system includes various types of computer readable media and interfaces for various other types of computer readable media. Electronic system 800 includes a bus 808, processing unit(s) 812, a system memory 804, a read-only memory (ROM) 810, a permanent storage device 802, an input device interface 814, an output device interface 806, and a network interface 816.

Bus 808 collectively represents all system, peripheral, and chipset buses that communicatively connect the numerous internal devices of electronic system 800. For instance, bus 808 communicatively connects processing unit(s) 812 with ROM 810, system memory 804, and permanent storage device 802.

From these various memory units, processing unit(s) 812 retrieves instructions to execute and data to process in order to execute the processes of the subject disclosure. The processing unit(s) can be a single processor or a multi-core processor in different implementations.

ROM 810 stores static data and instructions that are needed by processing unit(s) 812 and other modules of the electronic system. Permanent storage device 802, on the other hand, is a read-and-write memory device. This device is a non-volatile memory unit that stores instructions and data even when electronic system 800 is off. Some implementations of the subject disclosure use a mass-storage device (such as a magnetic or optical disk and its corresponding disk drive) as permanent storage device 802.

Other implementations use a removable storage device (such as a floppy disk, flash drive, and its corresponding disk drive) as permanent storage device 802. Like permanent storage device 802, system memory 804 is a read-and-write memory device. However, unlike storage device 802, system memory 804 is a volatile read-and-write memory, such a random access memory. System memory 804 stores some of the instructions and data that the processor needs at runtime. In some implementations, the processes of the subject disclosure are stored in system memory 804, permanent storage device 802, and/or ROM 810. For example, the various memory units include instructions for verifying user identity in accordance with some implementations. From these various memory units, processing unit(s) 812 retrieves instructions to execute and data to process in order to execute the processes of some implementations.

Bus 808 also connects to input and output device interfaces 814 and 806. Input device interface 814 enables the user to communicate information and select commands to the electronic system. Input devices used with input device interface 814 include, for example, alphanumeric keyboards and pointing devices (also called “cursor control devices”). Output device interfaces 806 enables, for example, the display of images generated by the electronic system 800. Output devices used with output device interface 806 include, for example, printers and display devices, such as cathode ray tubes (CRT) or liquid crystal displays (LCD). Some implementations include devices such as a touchscreen that functions as both input and output devices.

Finally, as shown in FIG. 8, bus 808 also couples electronic system 800 to a network (not shown) through a network interface 816. In this manner, the computer can be a part of a network of computers (such as a local area network (“LAN”), a wide area network (“WAN”), or an Intranet, or a network of networks, such as the Internet. Any or all components of electronic system 800 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A machine-implemented method for verifying user identity, the method comprising:
receiving a user input, wherein the user input is associated with verifying a user's identity on a server;
determining at least one parameter of a one-way function for processing the received user input, wherein the at least one parameter is associated with the server;
processing the user input with the one-way function based on the determined at least one parameter;
sending the processed user input to the server; and
receiving, in response to sending the processed user input, a verification of the user's identity from the server.

2. The method of claim 1, wherein the one-way function is a hash function for cryptographically processing the user input.

3. The method of claim 1, wherein the at least one parameter comprises a first parameter for identifying the server.

4. The method of claim 1, wherein the first parameter is a locally-stored parameter.

5. The method of claim 3, wherein the first parameter is sharable with multiple servers to identify the multiple servers.

6. The method of claim 3, wherein the first parameter uniquely identifies the server from among other servers.

7. The method of claim 1, wherein the at least one parameter comprises a second parameter for identifying a type of one-way function for processing the user input.

8. The method of claim 7, wherein the second parameter further specifies or alters how the identified type of one-way function works.

9. The method of claim 7, wherein the second parameter is a preset value which is specified within a login context associated with the server.

10. The method of claim 7, further comprising:
sending a request for identifying the type of one-way function to the server; and
receiving, in response to sending the request, the second parameter from the server.

11. The method of claim 1, wherein the receiving the user input, the determining the at least one parameter, the processing the user input, the sending the processed user input, and the receiving the verification are separately performed in association with a first server and a second server, and wherein the processed user input sent to the first server differs from the processed user input sent to the second server.

12. The method of claim 1, wherein the user input comprises at least one of a password or an answer to a security question.

13. A system for verifying user identity, the system comprising:
one or more processors; and
a machine-readable medium comprising instructions stored therein, which when executed by the processors, cause the processors to perform operations comprising:
receiving a user input, wherein the user input is associated with verifying a user's identity on a server;
determining at least one parameter of a hash function for cryptographically processing the received user input, wherein the at least one parameter is associated with the server;
processing the user input with the hash function based on the determined at least one parameter;
sending the processed user input to the server; and
receiving, in response to sending the processed user input, a verification of the user's identity from the server.

14. The system of claim 13, wherein the at least one parameter comprises a first parameter for identifying the server.

15. The system of claim 13, wherein the at least one parameter comprises a second parameter for identifying a type of hash function for processing the user input.

16. The method of claim 15, wherein the second parameter further specifies or alters how the identified type of one-way function works.

17. A machine-readable medium comprising instructions stored therein, which when executed by a system, cause the system to perform operations comprising:
receiving a user input, wherein the user input is associated with verifying a user's identity on a server;
sending a request for information to a server, the information for identifying a type of one-way function for processing the received user input;
receiving, in response to sending the request, the information from the server;
processing the user input with the one-way function based on the received information;
sending the processed user input to the server; and
receiving, in response to sending the processed user input, a verification of the user's identity from the server.

18. The machine-readable medium of claim 17, wherein the one-way function is a hash function for cryptographically processing the user input.

19. The machine-readable medium of claim 17, wherein the information is further for specifying or altering how the identified type of one-way function works.

20. A machine-implemented method of verifying user identify at a server, the method comprising:
receiving a request for information from a client device, the information for identifying a type of one-way function to use for processing a user input, wherein the user input is associated with verifying a user's identity for a service;
determining the information in response to the received request;
sending the determined information to the client device;
receiving, in response to sending the determined information, a processed user input from the client device; and
verifying the user's identity based on the processed user input.

21. The method of claim 20, wherein the one-way function is a hash function for cryptographically processing the user input.

22. The method of claim 20, further comprising:
sending a verification of the user's identify to the client.

23. The method of claim 20, wherein the information is further for specifying or altering how the identified type of one-way function works.
